(19) United States
(12) Patent Application Publication
(10) Pub. No.: US 2015/0344221 A1
(43) Pub. Date: Dec. 3, 2015

(54) FLAVOURED INSERT

(71) Applicant: Kraft Foods R & D, Inc., Deerfield, IL (US)

(72) Inventors: Amy L. Penner, Banbury (GB); David Cava, Banbury (GB)

(73) Assignee: Kraft Foods R & D, Inc., Deerfield, IL (US)

(21) Appl. No.: 14/653,801

(22) PCT Filed: Oct. 27, 2014
(86) PCT No.: PCT/IB2014/002320

§ 371 Date: Jun. 18, 2015

(30) Foreign Application Priority Data
Oct. 30, 2013 (GB) 1319174.7

(51) Int. Cl. B65D 85/804; A23L 2/38; A23F 5/26

(52) U.S. Cl. CPC B65D 85/8046; A23F 5/262; A23L 2/38; A23V 2002/00

(57) ABSTRACT

The present invention relates to a kit for preparing a beverage in a beverage preparation machine, the kit comprising at least one filter pod containing one or more soluble or extractable beverage ingredients and a separate porous sheet provided with a soluble flavouring ingredient.

This disclosure relates to a flavouring insert for use in beverage preparation machines. In particular, the disclosure relates to printed filter paper sheets for use in combination with standard filter-paper beverage preparation pods. For example, in one embodiment the disclosure provides a kit including a filter paper pod of roast and ground coffee, together with a disc of filter paper printed with a flavouring.

It is well known for consumers to prepare beverages at home which seek to reproduce the taste and quality of authentic beverages sold in cafes. One common way to reproduce coffee beverages, for example, relies on low pressure beverage machines (1-3 Bar) with filter paper pods holding beverage ingredients. A consumer can prepare a suitable beverage by placing such a pod of ingredients, containing for example roast and ground coffee, into the beverage preparation machine. The machine passes hot water through the pod to produce an extracted coffee beverage.

It is also known for the individual filter paper pods to contain multiple ingredients, including soluble flavourings ingredients. EP0756844, for example, discloses filter paper pods including roast and ground coffee, with soluble coffee as a flavouring. This is used to provide a stronger coffee flavour to the final beverage. Other more conventional flavourings, such as mint and vanilla are, of course, also known for providing flavoured coffee beverages.

As disclosed in WO2010/126365, it is known for the filter paper pods to be impregnated with chemicals, including taste modifiers. This allows for the ready flavouring of the filter paper used to form a filter paper pod. This avoids the need to evenly mix a flavouring ingredient in with the roast and ground coffee ingredient.

U.S. 2009/0095164 discloses the impregnation of filter-coffee filters with flavourings. Such filters are used at low pressure to produce variable volumes of coffee, as desired by the consumer.

U.S. Pat. No. 4,975,292 discloses flavoured inserts for placing inside drip-filter coffee filters. These inserts are placed inside the filters and then covered with ground coffee. The inserts help to provide a flavoured final beverage.

WO2006/080843 discloses the use of pouches filled with beverage ingredients. These can be used in combination in a single beverage brewing chamber to provide a flavoured beverage from the ingredients contained therein.

WO2006/043102 discloses a flexible pad for preparing a beverage. The pad contains non-soluble absorbent particles in combination with a beverage ingredient.

EP2478802 discloses a kit for providing a chocolate beverage. The kit comprises a sachet of powdered chocolate ingredients for emptying into a receptacle, and a filter paper pouch containing milk solids for brewing onto the chocolate ingredients.

Accordingly, it is desirable to provide an alternative method for providing a flavoured beverage which gives the consumer greater flexibility, a new product and process for preparing a beverage and/or tackle at least some of the problems associated with the prior art or, at least, to provide a commercially useful alternative thereto.

According to a first aspect, the present disclosure provides a kit for preparing a beverage in a beverage preparation machine, the kit comprising at least one filter pod containing one or more soluble or extractable beverage ingredients and a separate porous sheet provided with a soluble flavouring ingredient.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The kit is suitable for use in a conventional beverage preparation machine which works with filter pods. An example of such a machine is the low-pressure Senseo™ machine.

By low pressure it is meant a machine which operates by passing hot water at a pressure of 1-3 Bar above atmospheric pressure. Examples of pods suitable for use in such machines are well known, including the standard construction materials and dimensions.

The kit comprises at least one filter pod containing one or more soluble or extractable beverage ingredients. It will generally be the case that a single filter pod is used at a time. However, it is also known to subsequently brew a further pod into the same receptacle, or to use a combination such as a milk pod and a coffee pod.

Examples of soluble beverage ingredients include soluble coffee, milk powder, foamers, creamers, whiteners, sugar, sweetener, cocoa powder and the like. Examples of extractable materials include roast and ground coffee, chicory and tea.

The kit further comprises a separate porous sheet. By “separate” it is meant that the sheet does not form an integral part of the at least one filter pod. This does not preclude a step of adhering or attaching the filter pod to the sheet before use, although this will not generally be necessary. By “porous” it is meant that the sheet allows the passage of water through its structure. It is preferred that the porous sheet does not materially affect the flow of water through its structure. By “sheet” it is meant that it forms a planar body and does not have any cavity or structure suitable for surrounding bulk amounts of further ingredients. By sheet it is intended to exclude a further filter pod or a portion thereof. That is, it will have pores suitable for holding a limited amount of infused ingredients and two planar surfaces suitable for holding printed or painted ingredients thereon.

The porous sheet is provided with a soluble flavouring ingredient. Suitable ingredients are well known in the art. It is intended that the passage of water through the porous sheet will dissolve the soluble flavouring ingredient so that the final beverage is flavoured.

Preferably the separate porous sheet is made of filter paper. Filter paper is cheap and cost effective. Moreover, it is commonly used for beverage preparation and can readily be impregnated or printed with flavouring.

The inventors have found that the present invention allows for the provision of unique flavoured products. Specifically, because the flavourings are provided on porous sheets, they can fit in the brewing chamber with any conventional beverage ingredient pod. This means that the flavouring can be applied to any conventional ingredient, including a consumers existing stock of unflavoured pods.

The kit is preferably a single-serving kit. The kit allows for the production of reproducible beverages with a desirable flavour. In contrast, drip filter machines lead to the production of a variable strength of flavour since the flavouring will typically be removed from the sheet at a non-constant rate. A small beverage produced in a drip filter machine with a flavoured filter might have an overly strong flavour, whereas a beverage produced through an older filter would have little or no flavour. This variance has an adverse effect on consumer preference for the product.

It has also been found that it is desirable to have a separation between the steps of dissolving the flavouring and extracting/dissolving the beverage ingredient, such as the roast and ground coffee. This is provided when the sheet is placed above the filter pod, in use, so that the flavouring is not in direct contact with the beverage ingredient. This provides for full dissolution of the flavouring and full extraction or dissolution of the beverage ingredients. This is particularly the case in brewing machines which operate under pressure since these typically have a fixed brewing cycle duration, compared to drip filters where the precise brewing time is less critical and there is no risk of under-extracting a beverage. A similar effect is discussed in EP0756844, although this does not appreciate the benefits of providing a printed flavouring sheet.

A particular advantage of the provision of the soluble flavouring ingredients on a separate sheet lies in the avoidance of allergy and contamination risks. If the flavouring were to be printed directly onto filled or pre-filled filter paper pods on a factory line, then all of the flavourings would have to be present at the filling factory. Instead, the flavourings can be printed separately, at a different site or with simpler contamination controls required. In this way, nut flavourings can be provided, for example, together with other flavourings. In essence, the printing step is simpler because the printing is being made on a product which can be immediately packaged, rather than present as part of a filter pod production line.

In addition, the sheets are very cheap to produce and can be provided as a selection pack of flavours for consumers to choose their favourites. Since the sheets can be printed with logos and since the sheets are designed to overly existing pods, this also provides an opportunity to conceal competitor's branding at the last point of beverage preparation.

When dealing with the waste after brewing, the porous sheet, especially when it is filter paper like a conventional pod, has been found to stick to the pod. This means that the waste is no more difficult to handle than when brewing a standard pod in the brewing machine.

A preferred beverage contemplated by the present inventors includes a range of flavoured milkshakes. With these products a simple milk pod can be combined with one or a range of different flavoured sheets to produce thick flavoured milk beverages. As will be appreciated, these will be best produced with cold beverage medium and in a machine with means for foaming (such as an eductor) or in combination with a foamer or foam booster.

Another preferred beverage contemplated by the present inventors is flavoured coffees.

These can be prepared with a conventional roast and ground coffee pod in combination with a range of different flavoured sheets to produce flavoured coffee beverages. As will be appreciated, these will be best produced with hot beverage medium. Similarly, a range of flavoured hot chocolate beverages can be produced with a conventional cocoa powder and milk powder pod, in combination with a range of flavoured sheets.

Preferably the at least one filter pod contains milk powder, roast and ground coffee, soluble coffee, cocoa powder, chocolate, sugar, sweetener, tea or a mixture of two or more thereof. Preferably there is just one filter pod, the pod containing roast and ground coffee or milk powder.

Preferably the soluble flavouring ingredient is selected from almond, amaretto, anise, apple, brandy, caramel, cider, cinnamon, cherry, chocolate, mint, cocoa, crème de menthe, French vanilla, grape, hazelnut, Irish cream, lemon, macadamia nut, orange, peach, peppermint, pistachio, strawberry, vanilla, wintergreen or a mixture of two or more thereof. Alternatively, or in addition, the soluble flavouring ingredient is preferably selected from lavender, rosemary, nasturtium, dill, Roselle, marjoram, basil, borage, anice, German chamomile, chervil, coriander, angelica, caraway, lovage, lady's mantle, lemon grass, lemon balm, roman chamomile, rhubarb, bergamot, scented geranium, santolina, salad burnet, sweet cicely, stevia, yarrow, oregano, chives, tarragon, cresson, fennel, hyssop, lemon verbena, myrtle, bay, sage, curry plant, thyme or a mixture of two or more thereof.

Preferably the separate porous sheet is sized and shaped to have substantially the same outline in plan view as the at least one filter pod. This makes it easier for the consumer to pair the two components together either before placing in the brewing chamber or when placing them sequentially in the brewing chamber.

Preferably the separate porous sheet is provided with one or more lines of weakness. These lines of weakness, which may be, for example, these may be scored lines or perforations, allow the user to control the amount of flavouring introduced into the beverage machine by reducing the size of the sheet. Thus a sheet could be sold which can readily be reduced to a fraction (such as half) of its original size to make the flavouring more subtle. As a further alternative, the porous sheet may be provided to have multiple servings of flavouring or multiple different flavours on a single strip, whereby the consumer selects the flavour desired by tearing off the desired sheet.

Preferably the soluble flavouring ingredient is printed onto at least one surface of the separate porous sheet. The present inventors have found that printing allows for the controlled deposition of the desired amount of flavouring. In addition, the printing preferably allows for the provision of an indicating mark, image or text to inform the consumer of the flavouring used.

Preferably the soluble flavouring ingredient is an encapsulated flavouring ingredient. That is, the flavouring is provided with an encapsulating coating to protect the flavouring from oxygen, moisture and degradation. Preferably the flavouring is double encapsulated since this protects the ingredient to a greater extent. Encapsulation techniques for flavourings are well known in the art. U.S. 20080075813, for example, discloses some encapsulation techniques.

According to a second aspect there is provided a method for the preparation of a beverage in a beverage preparation machine using the kit disclosed herein, the method comprising passing an aqueous medium through the at least one filter pod and through the separate porous sheet, wherein the at least one filter pod and the separate porous sheet are arranged in the same brewing chamber.

Preferably the separate porous sheet is arranged above the at least one filter pod. This is advantageous because it has been found that any flavouring which is slow to dissolve does not hinder the through-flow of the beverage medium. If the flavouring is located below the pod, then there is a risk of flavouring detaching from the sheet and clogging the exit from the brewing chamber. In effect, the filter pod acts as a filter to retain any particles of flavour which are washed off the sheet and which might clog the machine.

Preferably the aqueous medium comprises hot water. By hot water it is meant from 70 to 99° C., more preferably from 80 to 95 and most preferably about 85° C. Alternative and as described above in relation to milkshakes, the beverage medium may be provided colder than or at room temperature (i.e. from 5 to 25, more preferably from 10 to 20° C.).

The invention will now be described in relation to the following non-limiting figures, in which:

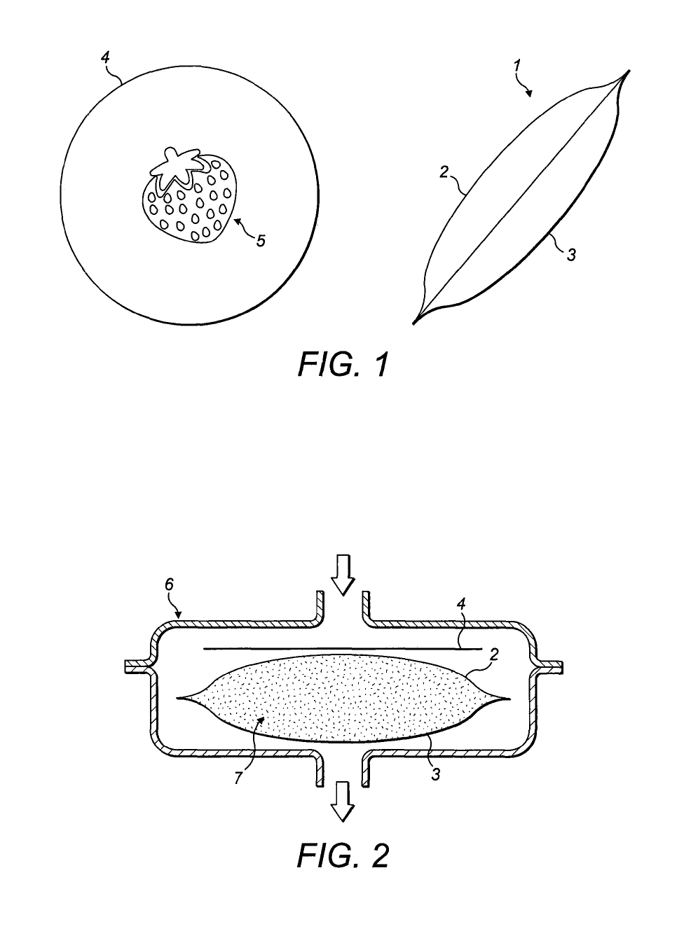

FIG. 1 shows a kit containing a filter paper pod 1, comprising first 2 and second 3 filter paper sheets, and a separate filter paper sheet 4 having a flavouring 5 printed thereon as a pattern.

FIG. 2 shows the kit in a beverage preparation chamber 6 in cross-section. The filter paper pod 1 contains a milk powder 7. The arrows show the flow of water/beverage in use.

The invention will now be described in relation to the following non-limiting examples.

### EXAMPLES

A beverage was prepared using a Senseo™ 7810 coffee brewing machine. The machine was loaded with a standard filter paper pouch containing roast and ground coffee and a standard filter paper pouch containing milk powder. A filter paper sheet was provided on top of the filter pods which had been printed with an encapsulated hazelnut flavouring on its surface (about 0.05 g). A 100 ml milky coffee beverage was produced with a hazelnut flavour.

A beverage was prepared using a Senseo™ 7810 coffee brewing machine. The machine was loaded with a standard filter paper pouch containing milk powder. A filter paper sheet was provided on top of the filter pod which had been printed with an encapsulated strawberry flavouring on its surface (about 0.05 g). A 100 ml hot strawberry milk drink was produced. A cooler version could be replicated as a milkshake.

A comparative example was performed using a Senseo™ 7810 coffee brewing machine. The machine was loaded with a standard filter paper pouch containing roast and ground coffee and a standard filter paper pouch containing milk powder. A filter paper sheet was provided below the filter pods which had been printed with an encapsulated hazelnut flavouring on its surface (about 0.05 g). A 100 ml milky coffee beverage was produced with a hazelnut flavour, but the extraction of the coffee was reduced and the drink tasted weak. It was theorised that the flavouring had partially clogged the machine outlet.

Although preferred embodiments of the invention have been described herein in detail, it will be understood by those skilled in the art that variations may be made thereto without departing from the scope of the invention or of the appended claims.

1. A kit for preparing a beverage in a beverage preparation machine, the kit comprising at least one filter pod containing one or more soluble or extractable beverage ingredients and a separate porous sheet provided with a soluble flavouring ingredient.

2. A kit according to claim 1, wherein the separate porous sheet is made of filter paper.

3. A kit according to claim 1, wherein the at least one filter pod contains milk powder, roast and ground coffee, soluble coffee, cocoa powder, sugar, sweetener, chocolate, tea or a mixture of two or more thereof.

4. A kit according to claim 3, having one filter pod, the pod containing roast and ground coffee or milk powder.

5. A kit according to claim 1, wherein the soluble flavouring ingredient is selected from almond, amaretto, anise, apple, brandy, caramel, cider, cinnamon, cherry, chocolate, mint, cocoa, crème de menthe, French vanilla, grape, hazelnut, Irish cream, lemon, macadamia nut, orange, peach, peppermint, pistachio, strawberry, vanilla, wintergreen or a mixture of two or more thereof.

6. A kit according to claim 1, wherein the soluble flavouring ingredient is selected from lavender, rosemary, nasturtium, dill, Roselle, marjoram, basil, borage, anice, German chamomile, chervil, coriander, angelica, caraway, lovage, lady's mantle, lemon grass, lemon balm, roman chamomile, rhubarb, bergamot, scented geranium, santolina, salad burnet, sweet cicely, stevia, yarrow, oregano, chives, tarragon, cresson, fennel, hyssop, lemon verbena, myrtle, bay, sage, curry plant, thyme or a mixture of two or more thereof.

7. A kit according to claim 1, wherein the separate porous sheet is sized and shaped to have substantially the same outline in plan view as the at least one filter pod.

8. A kit according to claim 1, wherein the separate porous sheet is provided with one or more lines of weakness.

9. A kit according to claim 1, wherein the soluble flavouring ingredient is printed onto at least one surface of the separate porous sheet.

10. A kit according to claim 1, wherein the soluble flavouring ingredient is a encapsulated flavouring ingredient, preferably a double encapsulated flavouring ingredient.

11. A method for the preparation of a beverage in a beverage preparation machine using the kit of claim 1, the method comprising passing an aqueous medium through the at least one filter pod and through the separate porous sheet, wherein the at least one filter pod and the separate porous sheet are arranged in the same brewing chamber.

12. The method according to claim 11, wherein the separate porous sheet is arranged above the at least one filter pod.

13. The method according to claim 11, wherein the aqueous medium comprises hot water.
